(19) United States
(12) Patent Application Publication
(10) Pub. No.: US 2026/0055714 A1
(43) Pub. Date: Feb. 26, 2026

(54) MULTI-COMPOSITION THERMAL MANAGEMENT COATING SYSTEMS FOR COMBUSTION CHAMBER COMPONENTS

(71) Applicant: Cummins Inc., Columbus, IN (US)

(72) Inventors: J. Steven Kolhouse, Columbus, IN (US); Daniel J. O’Connor, Columbus, IN (US); Eric A. Cantrell, Greenwood, IN (US); Manoj M. Thete, Columubs, IN (US)

(21) Appl. No.: 19/104,387

(22) PCT Filed: Aug. 18, 2023
(86) PCT No.: PCT/US23/72457

§ 371 Date: Feb. 18, 2025

Related U.S. Application Data
(60) Provisional application No. 63/373,087, filed on Aug. 22, 2022.

(51) Int. Cl. F01L 3/04; C01B 21/06; C01B 32/28; F01L 3/22; F02B 43/10

(52) U.S. Cl. CPC F01L 3/04; C01B 21/0602; C01B 32/28; F01L 3/22; F02B 43/10; F01L 2301/02

(57) ABSTRACT

An exhaust valve includes a valve head and a valve stem extending from the valve head. The valve head includes a combustion face and a seat face. The combustion face and the seat face are on opposing sides of the valve head. The seat face is configured to matingly engage an opposing surface. The valve head is formed of a base material. A valve thermal management composition coats at least a portion of the seat face and comprises increased thermal conductivity relative to the base material of the valve head.

### CROSS-REFERENCE

The present application claims priority to and the benefit of U.S. Application No. 63/373,087, filed Aug. 22, 2022, which is hereby incorporated by reference.

### TECHNICAL FIELD

The present disclosure relates to multi-composition thermal management coating systems for combustion chamber components for internal combustion engines.

### BACKGROUND

In at least some internal combustion engines including hydrogen-combusting internal combustion engines, including spark-ignited hydrogen-combusting internal combustion engines, hydrogen fuel is easily ignited within a broad range of air-fuel ratios. Pre-ignition can occur due to hot spots within the combustion chamber of sufficient temperature to ignite a hydrogen gas mixture. Such hot spots may occur in response to high load operation that results in undesirable elevated combustion chamber temperatures leading to pre-ignition or other ignition events.

### DISCLOSURE OF EXAMPLE EMBODIMENTS

For the purposes of clearly, concisely, and exactly describing example embodiments of the present disclosure, the manner, and process of making and using the same, and to enable the practice, making and use of the same, reference will now be made to certain example embodiments, including those illustrated in the figures, and specific language will be used to describe the same. It shall nevertheless be understood that no limitation of the scope of the invention is thereby created and that the invention includes and protects such alterations, modifications, and further applications of the example embodiments as would occur to one skilled in the art when provided with the benefit and insight of the present disclosure.

### SUMMARY OF THE DISCLOSURE

Example embodiments include to multi-composition thermal management coating systems for combustion chamber components of internal combustion engines. Some embodiments include exhaust valves with a multi-composition thermal management coating systems. Some embodiments include spark plugs with a multi-composition thermal management coating systems. Some embodiments include pistons with a multi-composition thermal management coating systems. Some embodiments include engine systems including one or more of exhaust valves, spark plugs, and pistons with a multi-composition thermal management coating systems. Further embodiments, forms, objects, features, advantages, aspects, and benefits shall become apparent from the following description and drawings.

### BRIEF DESCRIPTION OF THE DRAWINGS

FIG. 1 is a schematic diagram depicting certain aspects of an example engine system.

FIG. 2 a sectional schematic diagram depicting certain aspects of a cylinder head assembly of the example engine system of FIG. 1.

FIG. 3 a sectional schematic diagram depicting certain aspects of a spark plug of the cylinder head assembly of FIG. 2.

FIG. 4 a sectional schematic diagram depicting certain aspects of an exhaust valve of the cylinder head assembly of FIG. 2.

FIG. 5 a sectional schematic diagram depicting certain aspects of a piston of the example engine system of FIG. 1.

### DETAILED DESCRIPTION OF EXAMPLE EMBODIMENTS

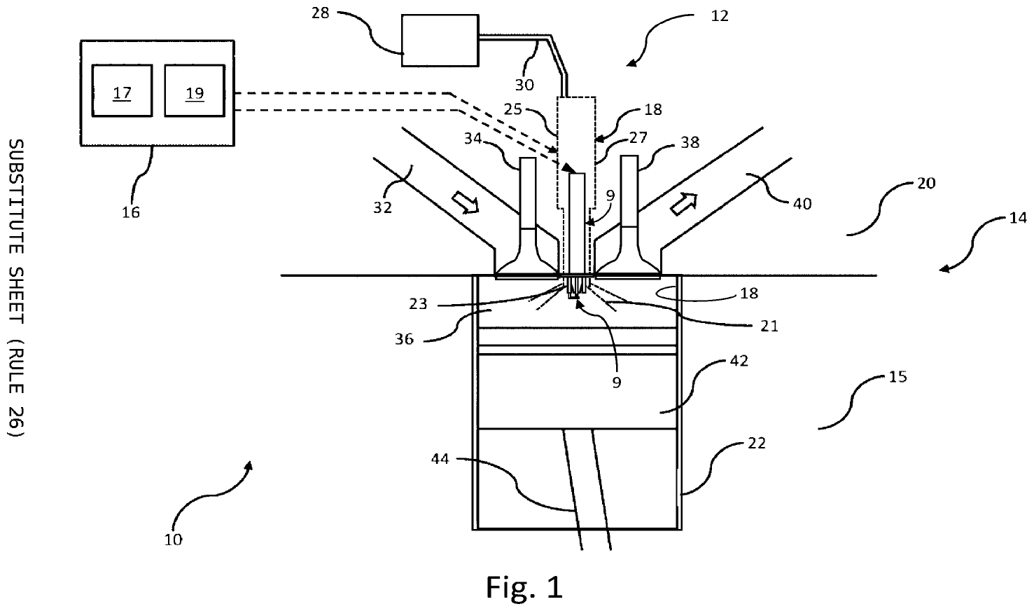

With reference to FIG. 1, there is illustrated an example internal combustion engine system 10 (also referred to herein as system 10). System 10 generally includes a fueling and ignition system 12, an engine 14, and a controller 16, and may also include other aspects and components.

Engine 14 includes an engine block 15 and cylinder head 20. A cylinder 22 is formed in the engine block 15 and includes a cylinder liner 18 or other interior surface defining a sidewall of a combustion chamber 36. A piston 42 connected to a crank arm 44 is disposed and in cylinder 22. The piston 42 reciprocally moves in the cylinder 16 between a top dead center position and a bottom dead center position. Combustion chamber 36 is bounded and defined by respective combustion-cylinder facing surfaces of piston 42, cylinder liner 18, cylinder head 20, intake valve 32, exhaust valve 38, injector 18, and spark plug 9.

Intake port 32 and exhaust port 40 are defined in cylinder head 20. Intake valve 34 is selectably operatively coupled with cylinder head 20 proximate an opening to intake port 32 and is configured and operable to selectably move from a seated or closed position to an unseated or open position to regulate a flow in intake charge air through intake port to combustion chamber 36. Exhaust valve 38 is selectably operatively coupled with cylinder head 20 proximate an opening to exhaust port 40 and is configured and operable to selectably move from a seated or closed position to an unseated or open position to regulate a flow combustion by-products or exhaust from combustion chamber 36 to exhaust port 40.

Fueling and ignition system 12 includes an injector 18 which is disposed in a bore defined in cylinder head 20, receives a supply of fuel 21 from a fuel source 28, and injects fuel 21 into combustion chamber 36. Operation of injector 18 is controlled by controller 16 as indicated by the dashed line extending between controller 16 and injector 18. In the illustrated example, injector 18 is provided in the form of a direct injector mounted in a cylinder head 20 for directly injecting fuel 21 into a cylinder 22 of engine 14 formed in engine block 15. In the illustrated example, injector 18 is configured and provided in the form of a hydrogen injector and fuel 21 is hydrogen. Injector 18 may be configured and controlled to deliver a number of types of fuel to cylinder 22 including, for example, diesel, natural gas, gasoline, diesel, other combustible fuels, and combinations of the foregoing and other fuels.

Fueling and ignition system 12 also includes a spark plug 9 which is which is disposed in a bore defined in cylinder head 20 and includes electrodes at its distal end which extend into or are otherwise exposed to combustion chamber 36. Operation of spark plug 9 is controlled by controller 16 as indicated by the dashed line extending between controller 16 and injector 18.

For simplicity, only certain aspects of system 10 are depicted in FIG. 1, it being appreciated that system 10 may include additional instances of the illustrated aspects as well as additional aspects not illustrated in FIG. 1. Thus, for example, while a single cylinder 22 and piston 42 are depicted in the view of FIG. 1, system 10 may include multiple cylinders in a number of forms and the same may be true for a number of other illustrated aspects including intake port 32, intake valve 34, exhaust valve 38, exhaust port 40, spark plug 9, and injector 18, among other aspects.

As shown, controller 16 generally includes a processor 17 and a non-transitory memory 19 having instructions that, in response to execution by processor 17, cause processor 17 to perform the various functions of controller 16 described herein. Processor 17, non-transitory memory 19, and controller 16 are not particularly limited and may, for example, be physically separate. Moreover, in certain embodiments, controller 16 may form a portion of a processing subsystem including one or more computing devices having memory, processing, and communication hardware. Controller 16 may be a single device or a distributed device, and the functions of the controller may be performed by hardware and/or as computer instructions on a non-transient computer readable storage medium, such as non-transitory memory 19.

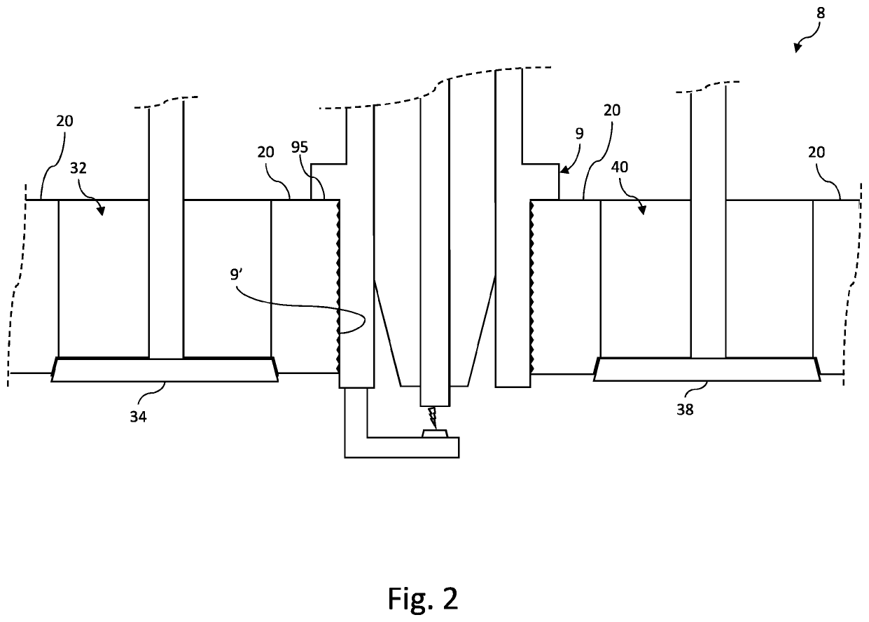

With reference to FIG. 2, there is illustrated a sectional view of a portion of a cylinder head assembly 8 of system 10. Cylinder head assembly 8 includes cylinder head 20 in which intake port 32, exhaust port 40, and injector bore 9′ are formed or otherwise provided. Cylinder head assembly 8 further includes intake valve 34 disposed in intake port 32, exhaust valve 38 disposed in exhaust port 40, and injector 9 disposed in injector bore 9′.

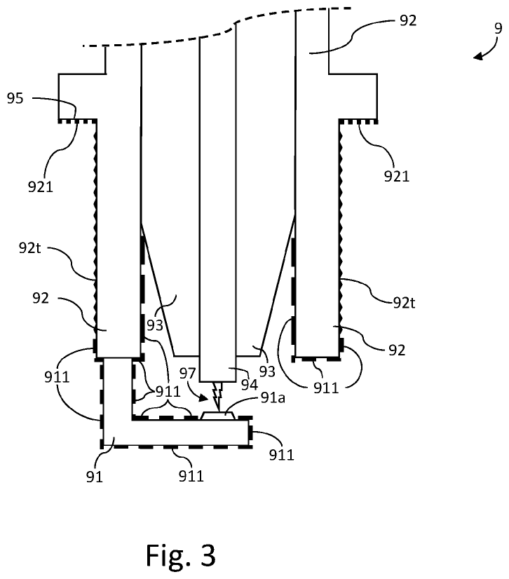

With reference to FIG. 3, there is illustrated a sectional view of a portion of spark plug 9 of cylinder head assembly 8 and system 10. It shall be appreciated that spark plug 9 is one example of an apparatus according to the present disclosure. Spark plug 9 includes a central electrode 94 which is typically configured and provided as a cathode. An insulator 93 surrounds a portion of the central electrode 94, but leaves uninsulated and exposed a distal portion of central electrode 94 proximate an air gap 97. Spark plug 9 further includes a side electrode 91 which is typically configured and provided as a ground electrode and includes a portion 91a positioned proximate the air gap 97. The air gap 97 extends intermediate the uninsulated, exposed portion of central electrode 91 and portion 91a of side electrode 91. A housing 92 is operatively and conductively coupled with the side electrode 91 and surrounds a portion of the insulator 93. Housing 92 includes a threaded portion 92t which is configured to engage a corresponding threaded portion of a spark plug bore 9′ defined in cylinder head 20 as illustrated in FIG. 2. Housing 92 further includes a including seating face 95 positioned and oriented to face an opposing surface of a cylinder head 20 when spark plug 9 is inserted in spark plug bore 9′.

Electrode 91 and housing 92 may be formed of a number of base materials. In some embodiments, electrode 91 is formed of a nickel alloy material or another suitable alloy material and the housing 91 is formed of a carbon steel plated with a corrosion resistant material such as a zinc or nickel alloy.

Spark plug 9 is provided with a multi-composition thermal management coating system. The multi-composition thermal management coating includes a first composition 911 coating at least a portion of electrode 91 and preferably further coating a portion of housing 92. In the illustrated embodiment, first composition 387 coats substantially all of electrode 91 with the exception of portion 91a. The first composition includes decreased thermal conductivity relative to a base material of electrode 91 and/or housing 92, e.g., relative to the base material of the electrode 91 and/or housing 92. In some embodiments, the decrease in thermal conductivity may be at least 5%. In some embodiments, the decrease in thermal conductivity may be at least 10%. In some embodiments, the decrease in thermal conductivity may between 5% and 10%.

The multi-composition thermal management coating includes a second composition 921 coating at least a portion of seating face 95 of housing 92. The second composition includes increased thermal conductivity relative to the base material of housing 92, e.g., relative to the base material of seating face 95. In some embodiments, the increase in thermal conductivity may be at least 5%. In some embodiments, the increase in thermal conductivity may be at least 10%. In some embodiments, the increase in thermal conductivity may between 5% and 10%.

In some embodiment, the first composition 911 may be provided in the form of a ceramic coating. In some embodiment, the ceramic coating may be selected from the group consisting of alumina (Al₂O₃), hafnia (HfO₂), silica (SiO₂), tantala (Ta₂O₅), titanium dioxide (TiO₂), yttria (Y₂O₃), yttria-stabilized zirconia (YSZ), and zirconia (ZrO₂). In some embodiments, the ceramic coating may comprise a combination including two or more of foregoing examples. In some embodiments, the ceramic coating may be applied using a physical vapor deposition (PVD) technique. Examples of such embodiment include a ceramic coating of alumina (Al₂O₃), titanium dioxide (TiO₂), or yttria (Y₂O₃) applied using a PVD technique. In other embodiments, the ceramic coating may be applied using a spray technique, or other technique suitable for a given ceramic coating composition. In some embodiments, the ceramic coating may be applied to components of a spark plug such as spark plug 9 prior to assembly of the spark plug.

In some embodiment, the second composition 921 may be provided in the form of a nitride coating composition. In some such embodiments, the nitride coating composition may comprise an aluminum chromium nitride (Al-Cr-N) composition, an aluminum titanium nitride (Al-Ti-N) composition, a boron nitride (B-N) composition, a chromium nitride (Cr-N) composition, a molybdenum nitride (Mo-N) composition, a titanium aluminum nitride (Ti-Al-N) composition, or a titanium nitride (Ti-N) composition. The second composition may be applied using a physical vapor deposition (PVD) technique.

In embodiments wherein the second composition 921 is provided in the form of a Al-Ti-N composition, the Al-Ti-N composition may be selected from the group consisting of Al55Ti45N (a relative composition of 55% Al to 45% Ti), Al60Ti40N (a relative composition of 60% Al to 40% Ti), and Al66Ti34N (a relative composition of 66% Al to 34% Ti). It shall be appreciated that the relative compositions of the foregoing examples may vary from the stated percentages, for example, by +/−2.5 or another percentage variation. In embodiments such as the foregoing examples, the second composition may be applied using a physical vapor deposition (PVD) technique.

In embodiments wherein the second composition 921 is provided in the form of a Ti-Al-N composition, the Ti-Al-N composition may be selected from the group consisting of Ti75Al25N (a relative composition of 75% Ti to 25% Al), Ti66Al34N (a relative composition of 66% Ti to 34% Al), Ti60Al40N (a relative composition of 60% Ti to 40% Al), Ti55Al45N (a relative composition of 55% Ti to 45% Al), and Ti50Al50N (a relative composition of 50% Ti to 50% Al). It shall be appreciated that the relative compositions of the foregoing examples may vary from the stated percentages, for example, by +/−2.5 or another percentage variation. In embodiments such as the foregoing examples, the second composition may be applied using a physical vapor deposition (PVD) technique.

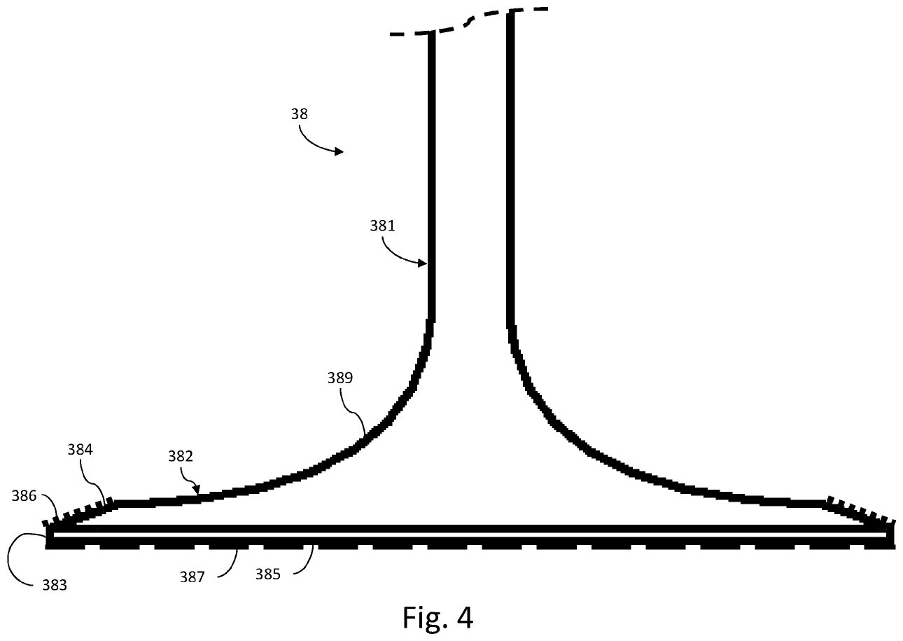

With reference to FIG. 4, there is illustrated a sectional view of a portion of exhaust valve 38 which is formed of a base material and includes a valve head 382 and a valve stem 381 extending from the valve head 382. It shall be appreciated that exhaust valve 38 is one example of an apparatus according to the present disclosure. The valve head 382 includes a fillet 389 from which the valve stem 381 extends. Valve head 382 also includes a seating face 384 which is configured and oriented to face and seat against a surface of exhaust port 40 of cylinder head 20. Valve head 382 also includes a combustion face 385 which may be separate from seating face 384 by a margin 383 and which is configured and oriented to face combustion chamber 36.

Valve head 382 may be formed of a number of base materials. In some embodiments, valve head 382 may be formed of a steel composition base material. Example steel composition base materials include 21-4N Austenitic steel, and DIN 1.4882 Austenitic steel as well as other steel compositions. In some embodiments, valve head 382 may be formed of a titanium composition base material. Example titanium composition base materials include Ti-834 as well as other titanium compositions. In some embodiments, valve head 382 may be formed of a superalloy composition base material. Example superalloy base materials include UNS N07080/W. Nr. 2.4952 & 2.4631 which are wrought, age-hardenable nickel-chromium alloys, strengthened by additions of titanium, aluminum and carbon commercially available as NIMONIC® alloy 80A, and UNS N07751 which is a precipitation hardenable nickel-chromium alloy commercially available as INCONEL® 751 as well as other superalloy compositions. In some embodiments, the base material of valve head 382 may include additional materials welded with the foregoing or other base materials including, for example, and of a range of cobalt-based alloys, with significant proportions of chromium (up to 33%) and tungsten (up to 18%) and optimally including nickel or molybdenum commercially available as STELLITE® alloys.

Valve head 382 is provided with a multi-composition thermal management coating system. The multi-composition thermal management coating includes a first composition 387 coating at least a portion of combustion face 385. In the illustrated embodiment, first composition 387 coats substantially all of combustion face 385. In some embodiments, first composition 387 may coat a portion of combustion face 385 may additionally coat a portion or all of margin 383. The first composition includes decreased thermal conductivity relative to a base material of valve head 382, e.g., relative to the base material of the combustion face 385. In some embodiments, the decrease in thermal conductivity may be at least 5%. In some embodiments, the decrease in thermal conductivity may be at least 10%. In some embodiments, the decrease in thermal conductivity may between 5% and 10%.

The multi-composition thermal management coating includes a second composition 386 coating at least a portion of seating face 384. The second composition includes increased thermal conductivity relative to the base material of valve head 382, e.g., relative to the base material of seating face 384. In some embodiments, the increase in thermal conductivity may be at least 5%. In some embodiments, the increase in thermal conductivity may be at least 10%. In some embodiments, the increase in thermal conductivity may between 5% and 10%.

In some embodiment, the first composition 387 may be provided in the form of a ceramic coating. In some embodiment, the ceramic coating may be selected from the group consisting of alumina (Al₂O₃), hafnia (HfO₂), silica (SiO₂), tantala (Ta₂O₅), titanium dioxide (TiO₂), yttria (Y₂O₃), yttria-stabilized zirconia (YSZ), and zirconia (ZrO₂). In some embodiments, the ceramic coating may comprise a combination including two or more of foregoing examples. In some embodiments, the ceramic coating may be applied using a physical vapor deposition (PVD) technique. Examples of such embodiment include a ceramic coating of alumina (Al₂O₃), titanium dioxide (TiO₂), or yttria (Y₂O₃) applied using a PVD technique. In other embodiments, the ceramic coating may be applied using a spray technique, or other technique suitable for a given ceramic coating composition.

In some embodiment, the second composition 386 may be provided in the form of a nitride coating composition. In some such embodiments, the nitride coating composition may comprise an aluminum chromium nitride (Al-Cr-N) composition, an aluminum titanium nitride (Al-Ti-N) composition, a boron nitride (B-N) composition, a chromium nitride (Cr-N) composition, a molybdenum nitride (Mo-N) composition, a titanium aluminum nitride (Ti-Al-N) composition, or a titanium nitride (Ti-N) composition. The second composition may be applied using a physical vapor deposition (PVD) technique.

In embodiments wherein the second composition 386 is provided in the form of a Al-Ti-N composition, the Al-Ti-N composition may be selected from the group consisting of Al55Ti45N (a relative composition of 55% Al to 45% Ti), Al60Ti40N (a relative composition of 60% Al to 40% Ti), and Al66Ti34N (a relative composition of 66% Al to 34% Ti). It shall be appreciated that the relative compositions of the foregoing examples may vary from the stated percentages, for example, by +/−2.5 or another percentage variation. In embodiments such as the foregoing examples, the second composition may be applied using a physical vapor deposition (PVD) technique.

In embodiments wherein the second composition 386 is provided in the form of a Ti-Al-N composition, the Ti-Al-N composition may be selected from the group consisting of Ti75Al25N (a relative composition of 75% Ti to 25% Al), Ti66Al34N (a relative composition of 66% Ti to 34% Al), Ti60Al40N (a relative composition of 60% Ti to 40% Al), Ti55Al45N (a relative composition of 55% Ti to 45% Al), and Ti50Al50N (a relative composition of 50% Ti to 50% Al). It shall be appreciated that the relative compositions of the foregoing examples may vary from the stated percentages, for example, by +/−2.5 or another percentage variation. In embodiments such as the foregoing examples, the second composition may be applied using a physical vapor deposition (PVD) technique.

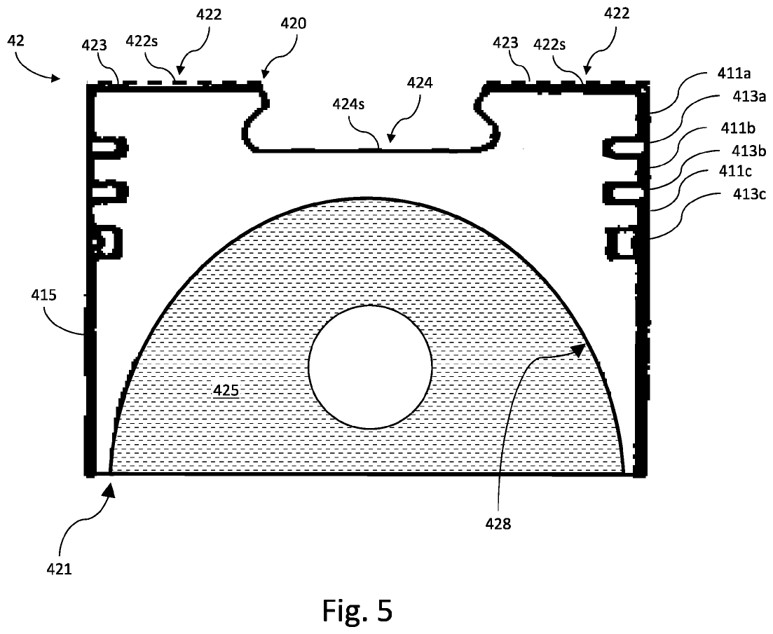

With reference to FIG. 5, there is illustrated a sectional view of a portion of piston 42 which is formed of a base material and includes a crown 422, a bowl 424, a plurality of lands 411a, 411b, 411c, a plurality of ring grooves 413a, 413b, 413c, a skirt 415, and an underside or bottom 421. It shall be appreciated that piston 42 is one example of an apparatus according to the present disclosure. Piston rings (not illustrated) may be provided in the plurality of ring grooves 413a, 413b, 413c. Piston 42 includes a combustion face 420 configured and oriented to face combustion chamber 36. The combustion face 420 includes a crown surface 422s and a bowl surface 424s. Piston 42 also includes a bottom face 428 configured and oriented to face away from combustion chamber 36.

Piston 42 may be formed of a number of base materials. In some embodiments, piston 42 may be formed of a steel composition base material. Example steel composition base materials include vanadium steels, chromium vanadium steels, 4140H steel, and 38MnSiVS5 steel, as well as other steel compositions. In some embodiments, piston 42 may be formed of an aluminum composition base material. Example aluminum composition base materials include aluminum silicon alloys such as 2618 Aluminum and 4032 Aluminum as well as other aluminum compositions. In some embodiments, piston 42 may be formed of combinations of steel materials and other materials, for example, articulated pistons with forged steel crowns and aluminum skirts.

Piston 42 is provided with a multi-composition thermal management coating system. The multi-composition thermal management coating includes a first composition 423 coating at least a portion of the combustion face 420. In the illustrated embodiment, first composition 423 coats substantially all of crown surface 422s. In some embodiments, first composition 423 may coat a portion of crown surface 422s, for example, an annular outer 25%, annular outer 50%, annular outer 75% or another portion of crown surface 422s. In some embodiments, first composition 423 may additionally or alternatively coat a portion or all of bowl surface 424s. The first composition includes decreased thermal conductivity relative to a base material of the piston 42, e.g., relative to the base material of the combustion face 420. In some embodiments, the decrease in thermal conductivity may be at least 5%. In some embodiments, the decrease in thermal conductivity may be at least 10%. In some embodiments, the decrease in thermal conductivity may between 5% and 10%. The multi-composition thermal management coating includes a second composition 425 coating at least a portion of bottom face 428. The second composition includes increased thermal conductivity relative to the base material of the piston 42, e.g., relative to the base material of the bottom face 428. In some embodiments, the increase in thermal conductivity may be at least 5%. In some embodiments, the increase in thermal conductivity may be at least 10%. In some embodiments, the increase in thermal conductivity may between 5% and 10%.

In some embodiment, the first composition 423 may be provided in the form of a ceramic coating. In some embodiment, the ceramic coating may be selected from the group consisting of alumina (Al₂O₃), hafnia (HfO₂), silica (SiO₂), tantala (Ta₂O₅), titanium dioxide (TiO₂), yttria (Y₂O₃), yttria-stabilized zirconia (YSZ), and zirconia (ZrO₂). In some embodiments, the ceramic coating may comprise a combination including two or more of foregoing examples. In some embodiments, the ceramic coating may be applied using a physical vapor deposition (PVD) technique. Examples of such embodiment include a ceramic coating of alumina (Al₂O₃), titanium dioxide (TiO₂), or yttria (Y₂O₃) applied using a PVD technique. In other embodiments, the ceramic coating may be applied using a spray technique, or other technique suitable for a given ceramic coating composition.

In some embodiment, the second composition 425 may be provided in the form of a nitride coating composition. In some such embodiments, the nitride coating composition may comprise an aluminum chromium nitride (Al-Cr-N) composition, an aluminum titanium nitride (Al-Ti-N) composition, a boron nitride (B-N) composition, a chromium nitride (Cr-N) composition, a molybdenum nitride (Mo-N) composition, a titanium aluminum nitride (Ti-Al-N) composition, or a titanium nitride (Ti-N) composition. The second composition may be applied using a physical vapor deposition (PVD) technique.

In embodiments wherein the second composition 425 is provided in the form of a Al-Ti-N composition, the Al-Ti-N composition may be selected from the group consisting of Al55Ti45N (a relative composition of 55% Al to 45% Ti), Al60Ti40N (a relative composition of 60% Al to 40% Ti), and Al66Ti34N (a relative composition of 66% Al to 34% Ti). It shall be appreciated that the relative compositions of the foregoing examples may vary from the stated percentages, for example, by +/−2.5 or another percentage variation. In embodiments such as the foregoing examples, the second composition may be applied using a physical vapor deposition (PVD) technique.

In embodiments wherein the second composition 425 is provided in the form of a Ti-Al-N composition, the Ti-Al-N composition may be selected from the group consisting of Ti75Al25N (a relative composition of 75% Ti to 25% Al), Ti66Al34N (a relative composition of 66% Ti to 34% Al), Ti60Al40N (a relative composition of 60% Ti to 40% Al), Ti55Al45N (a relative composition of 55% Ti to 45% Al), and Ti50Al50N (a relative composition of 50% Ti to 50% Al). It shall be appreciated that the relative compositions of the foregoing examples may vary from the stated percentages, for example, by +/−2.5 or another percentage variation. In embodiments such as the foregoing examples, the second composition may be applied using a physical vapor deposition (PVD) technique. In some embodiment, the second composition 425 may be provided in the form of a diamond-like carbon (DLC) composition. In some embodiment, the DLC composition comprises a tetrahedral amorphous carbon (ta-C) composition.

As illustrated by this detailed description of example embodiments, the present disclosure contemplates and includes a plurality of embodiments including the following examples. A first example embodiment is an apparatus comprising: an exhaust valve including a valve head and a valve stem extending from the valve head, the valve head including a combustion face and a seat face, the combustion face and the seat face being on opposing sides of the valve head, the seat face being configured to matingly engage an opposing surface, the valve head being formed of a base material; and a valve thermal management composition coating at least a portion of the seat face, the valve thermal management composition comprising increased thermal conductivity relative to the base material of the valve head.

A second example embodiment includes the features of the first example embodiment, wherein the valve thermal management composition comprises a nitride coating composition.

A third example embodiment includes the features of the second example embodiment, wherein the nitride coating composition is selected from the group consisting of an aluminum chromium nitride (Al-Cr-N) composition, an aluminum titanium nitride (Al-Ti-N) composition, a boron nitride (B-N) composition, a chromium nitride (Cr-N) composition, a molybdenum nitride (Mo-N) composition, a titanium aluminum nitride (Ti-Al-N) composition, and a titanium nitride (Ti-N) composition.

A fourth example embodiment includes the features of the first example embodiment, wherein the valve thermal management composition comprises a titanium aluminum nitride composition.

A fifth example embodiment includes the features of the fourth example embodiment, wherein the titanium aluminum nitride composition is selected from the group consisting of Ti75Al25N, Ti66Al34N, Ti60Al40N, Ti55Al45N, and Ti50Al50N.

A sixth example embodiment includes the features of the first example embodiment, wherein the valve thermal management composition comprises an aluminum titanium nitride composition.

A seventh example embodiment includes the features of the sixth example embodiment, wherein the aluminum titanium nitride composition is selected from the group consisting of Al55Ti45N, Al60Ti40N, and Al66Ti34N.

A eighth example embodiment includes the features of the first example embodiment, comprising a second valve thermal management composition coating at least a portion of the combustion face, the second valve thermal management composition comprising decreased thermal conductivity relative to a base material of the valve head.

A ninth example embodiment includes the features of the eighth example embodiment, wherein the second valve thermal management composition management composition comprises a ceramic coating.

A tenth example embodiment includes the features of the ninth example embodiment, wherein the ceramic coating is selected from the group consisting of alumina (Al2O₃), hafnia (HfO₂), silica (SiO2), tantala (Ta₂O₅), titanium dioxide (TiO₂), yttria (Y₂O₃), yttria-stabilized zirconia (YSZ), and zirconia (ZrO₂).

An eleventh example embodiment includes the features of any one of the first through tenth example embodiments, wherein the base material of the valve head is a steel composition.

A twelfth example embodiment includes the features of any one of the first through tenth example embodiments, wherein the base material of the valve head is an aluminum composition.

A thirteenth example embodiment includes the features of any one of the first through tenth example embodiments, comprising: a cylinder head comprising a port, the exhaust valve being moveably disposed in the port, the port including a seat surface contacting the valve thermal management composition coating the seat face of valve head with the exhaust valve in a closed position and spaced apart from the valve thermal management composition coating the seat face of valve head with the exhaust valve in an open position.

A fourteenth example embodiment includes the features of the thirteenth example embodiment, comprising: a block defining a cylinder bore, the cylinder head being coupled with the block; and a piston reciprocally disposed in the cylinder bore; wherein the exhaust valve being in the open position provides a fluid flow path between the cylinder bore and the port, and the exhaust valve being in the closed position occludes the fluid flow path between the cylinder bore and the port.

A fifteenth example embodiment includes the features of the fourteenth example embodiment, wherein the piston comprises a base material, a combustion face facing the cylinder head, a bottom face facing an opposing direction from the combustion face, and a piston thermal management composition coating disposed on the bottom face, the piston thermal management composition comprising increased thermal conductivity relative to the base material of the piston.

A sixteenth example embodiment includes the features of the fifteenth example embodiment, wherein the piston thermal management composition comprises a nitride coating composition.

A seventeenth example embodiment includes the features of the sixteenth example embodiment, wherein the nitride coating composition is selected from the group consisting of an aluminum chromium nitride (Al-Cr-N) composition, an aluminum titanium nitride (Al-Ti-N) composition, a boron nitride (B-N) composition, a chromium nitride (Cr-N) composition, a molybdenum nitride (Mo-N) composition, a titanium aluminum nitride (Ti-Al-N) composition, and a titanium nitride (Ti-N) composition.

A eighteenth example embodiment includes the features of the fifteenth example embodiment, wherein the piston thermal management composition comprises a titanium aluminum nitride composition.

A nineteenth example embodiment includes the features of the eighteenth example embodiment, wherein the titanium aluminum nitride composition is selected from the group consisting of Ti75Al25N, Ti66Al34N, Ti60Al40N, Ti55Al45N, and Ti50Al50N.

A twentieth example embodiment includes the features of the fifteenth example embodiment, wherein the piston thermal management composition comprises an aluminum titanium nitride composition.

A twenty-first example embodiment includes the features of the twentieth example embodiment, wherein the aluminum titanium nitride composition is selected from the group consisting of Al55Ti45N, Al60Ti40N, and Al66Ti34N.

A twenty-second example embodiment includes the features of the fifteenth example embodiment, wherein the piston thermal management composition comprises a diamond-like carbon (DLC) composition.

A twenty-third example embodiment includes the features of the twenty-second example embodiment, wherein the DLC composition comprises a tetrahedral amorphous carbon (ta-C) composition.

A twenty-fourth example embodiment includes the features of the fifteenth example embodiment, wherein the base material of the piston is a steel composition.

A twenty-fifth example embodiment includes the features of the fifteenth example embodiment, wherein the base material of the piston is an aluminum composition.

A twenty-sixth example embodiment includes the features of the fifteenth example embodiment, wherein the apparatuses is provided in a direct, in-cylinder injection hydrogen-combusting engine system.

A twenty-seventh example embodiment includes the features of the fifteenth example embodiment, comprising a second piston thermal management composition coating disposed on the combustion face, the second piston thermal management composition comprising decreased thermal conductivity relative to the base material of the piston.

A twenty-eighth example embodiment includes the features of the twenty-seventh example embodiment, wherein the second piston thermal management composition comprises a ceramic coating.

A twenty-ninth example embodiment includes the features of the twenty-eighth example embodiment 29. The apparatus of claim 28, wherein the ceramic coating is selected from the group consisting of alumina (Al2O3), hafnia (HfO₂), silica (SiO2), tantala (Ta₂O₅), titanium dioxide (TiO₂), yttria (Y₂O₃), yttria-stabilized zirconia (YSZ), and zirconia (ZrO₂).

A thirtieth example embodiment is an apparatus comprising: a piston formed of a base material, the piston including a combustion face and a bottom face facing an opposing direction from the combustion face; and a piston thermal management composition coating disposed on the bottom face, the piston thermal management composition comprising increased thermal conductivity relative to the base material of the piston.

A thirty-first example embodiment includes the features of the thirtieth example embodiment, wherein the piston thermal management composition comprises a nitride coating composition.

A thirty-second example embodiment includes the features of the thirty-first example embodiment, wherein the nitride coating composition is selected from the group consisting of an aluminum chromium nitride (Al-Cr-N) composition, an aluminum titanium nitride (Al-Ti-N) composition, a boron nitride (B-N) composition, a chromium nitride (Cr-N) composition, a molybdenum nitride (Mo-N) composition, a titanium aluminum nitride (Ti-Al-N) composition, and a titanium nitride (Ti-N) composition.

A thirty-third example embodiment includes the features of the thirtieth example embodiment, wherein the piston thermal management composition comprises a titanium aluminum nitride composition.

A thirty-fourth example embodiment includes the features of the thirty-third example embodiment, wherein the titanium aluminum nitride composition is selected from the group consisting of Ti75Al25N, Ti66Al34N, Ti60Al40N, Ti55Al45N, and Ti50Al50N.

A thirty-fifth example embodiment includes the features of the thirtieth example embodiment, wherein the piston thermal management composition comprises an aluminum titanium nitride composition.

A thirty-sixth example embodiment includes the features of the thirty-fifth example embodiment, wherein the aluminum titanium nitride composition is selected from the group consisting of Al55Ti45N, Al60Ti40N, and Al66Ti34N.

A thirty-seventh example embodiment includes the features of the thirtieth example embodiment, wherein the piston thermal management composition comprises a diamond-like carbon (DLC) composition.

A thirty-eighth example embodiment includes the features of the thirty-seventh example embodiment, wherein the DLC composition comprises a tetrahedral amorphous carbon (ta-C) composition.

A thirty-ninth example embodiment includes the features of the thirtieth example embodiment, comprising a second piston thermal management composition coating disposed on the combustion face, the second piston thermal management composition comprising decreased thermal conductivity relative to the base material of the piston.

A fortieth example embodiment includes the features of the thirty-ninth example embodiment, wherein the second piston thermal management composition comprises a ceramic coating.

A fourth-first example embodiment includes the features of the fortieth example embodiment, wherein the ceramic coating is selected from the group consisting of alumina (Al2O3), hafnia (HfO₂), silica (SiO2), tantala (Ta₂O₅), titanium dioxide (TiO₂), yttria (Y₂O₃), yttria-stabilized zirconia (YSZ), and zirconia (ZrO₂).

A fourth-second example embodiment includes the features of any one of the thirtieth through forty-first embodiments, comprising: a block defining a cylinder bore, the piston being reciprocally disposed in the cylinder bore; an exhaust valve including a valve head and a valve stem extending from the valve head, the valve head including a combustion face and a seat face, the combustion face and the seat face being on opposing sides of the valve head, the seat face being configured to matingly engage an opposing surface, the valve head being formed of a base material; and a cylinder head comprising a port, the exhaust valve being moveably disposed in the port; wherein the exhaust valve being in an open position provides a fluid flow path between the cylinder bore and the port, and the exhaust valve being in a closed position occludes the fluid flow path between the cylinder bore and the port.

A forty-third example embodiment includes the features of the forty-second example embodiment, comprising a valve thermal management composition coating at least a portion of the seat face of the exhaust valve, the valve thermal management composition comprising increased thermal conductivity relative to the base material of the valve head.

A forty-fourth example embodiment includes the features of the forty-third example embodiment, wherein the valve thermal management composition comprises a nitride coating composition.

A forty-fifth example embodiment includes the features of the forty-fourth example embodiment, wherein the nitride coating composition is selected from the group consisting of an aluminum chromium nitride (Al-Cr-N) composition, an aluminum titanium nitride (Al-Ti-N) composition, a boron nitride (B-N) composition, a chromium nitride (Cr-N) composition, a molybdenum nitride (Mo-N) composition, a titanium aluminum nitride (Ti-Al-N) composition, and a titanium nitride (Ti-N) composition.

A forty-sixth example embodiment includes the features of the forty-third example embodiment, wherein the valve thermal management composition comprises a titanium aluminum nitride composition.

A forty-seventh example embodiment includes the features of the forty-sixth example embodiment, wherein the titanium aluminum nitride composition is selected from the group consisting of Ti75Al25N, Ti66Al34N, Ti60Al40N, Ti55Al45N, and Ti50Al50N.

A forty-eighth example embodiment includes the features of the forty-seventh example embodiment, wherein the valve thermal management composition comprises an aluminum titanium nitride composition.

A forty-ninth example embodiment includes the features of the forty-eighth example embodiment, wherein the aluminum titanium nitride composition is selected from the group consisting of Al55Ti45N, Al60Ti40N, and Al66Ti34N.

A fiftieth example embodiment includes the features of the forty-third example embodiment, comprising a second valve thermal management composition coating at least a portion of the combustion face, the second valve thermal management composition comprising decreased thermal conductivity relative to a base material of the valve head.

A fifty-first example embodiment includes the features of the fiftieth example embodiment, wherein the second valve thermal management composition management composition comprises a ceramic coating.

A fifty-second example embodiment includes the features of the fifty-first example embodiment, wherein the ceramic coating is selected from the group consisting of alumina (Al2O3), hafnia (HfO₂), silica (SiO2), tantala (Ta₂O₅), titanium dioxide (TiO₂), yttria (Y₂O₃), yttria-stabilized zirconia (YSZ), and zirconia (ZrO₂).

A fifty-third example embodiment includes the features of the forty-second example embodiment, wherein the base material of the valve head is a steel composition.

A fifty-fourth example embodiment includes the features of the forty-second example embodiment, wherein the base material of the valve head is an aluminum composition.

While example embodiments of the disclosure have been illustrated and described in detail in the drawings and foregoing description, the same is to be considered as illustrative and not restrictive in character, it being understood that only certain example embodiments have been shown and described and that all changes and modifications that come within the spirit of the claimed inventions are desired to be protected. It should be understood that while the use of words such as preferable, preferably, preferred, or more preferred utilized in the description above indicates that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. An apparatus comprising:
an exhaust valve including a valve head and a valve stem extending from the valve head, the valve head including a combustion face and a seat face, the combustion face and the seat face being on opposing sides of the valve head, the seat face being configured to matingly engage an opposing surface, the valve head being formed of a base material; and
a valve thermal management composition coating at least a portion of the seat face, the valve thermal management composition comprising increased thermal conductivity relative to the base material of the valve head.

2. The apparatus of claim 1, wherein the valve thermal management composition comprises one of a nitride coating composition, a titanium aluminum nitride composition, and an aluminum titanium nitride composition.

3. The apparatus of claim 2, wherein the valve thermal management composition comprises the nitride coating composition and the nitride coating composition is selected from the group consisting of an aluminum chromium nitride (Al-Cr-N) composition, an aluminum titanium nitride (Al-Ti-N) composition, a boron nitride (B-N) composition, a chromium nitride (Cr-N) composition, a molybdenum nitride (Mo-N) composition, a titanium aluminum nitride (Ti-Al-N) composition, and a titanium nitride (Ti-N) composition.

4. (canceled)

5. The apparatus of claim 2, wherein the valve thermal management composition comprises the titanium aluminum nitride composition and the titanium aluminum nitride composition is selected from the group consisting of Ti75Al25N, Ti66Al34N, Ti60Al40N, Ti55Al45N, and Ti50Al50N.

6. (canceled)

7. The apparatus of claim 2, wherein the valve thermal management composition comprises the aluminum titanium nitride composition and the aluminum titanium nitride composition is selected from the group consisting of Al55Ti45N, Al60Ti40N, and Al66Ti34N.

8. The apparatus of claim 1, comprising a second valve thermal management composition coating at least a portion of the combustion face, the second valve thermal management composition comprising decreased thermal conductivity relative to a base material of the valve head.

9. The apparatus of claim 8, wherein the second valve thermal management composition management composition comprises a ceramic coating.

10. The apparatus of claim 9, wherein the ceramic coating is selected from the group consisting of alumina (Al2O3), hafnia (HfO₂), silica (SiO2), tantala (Ta₂O₅), titanium dioxide (TiO₂), yttria (Y₂O₃), yttria-stabilized zirconia (YSZ), and zirconia (ZrO₂).

11. The apparatus of claim 1, wherein the base material of the valve head comprises one of a steel composition and an aluminum composition.

12. (canceled)

13. The apparatus of claim 1, comprising:
a cylinder head comprising a port, the exhaust valve being moveably disposed in the port, the port including a seat surface contacting the valve thermal management composition coating the seat face of valve head with the exhaust valve in a closed position and spaced apart from the valve thermal management composition coating the seat face of valve head with the exhaust valve in an open position.

14. The apparatus of claim 13, comprising:
a block defining a cylinder bore, the cylinder head being coupled with the block; and
a piston reciprocally disposed in the cylinder bore;
wherein the exhaust valve being in the open position provides a fluid flow path between the cylinder bore and the port, and the exhaust valve being in the closed position occludes the fluid flow path between the cylinder bore and the port.

15. The apparatus of claim 14, wherein the piston comprises a base material, a combustion face facing the cylinder head, a bottom face facing an opposing direction from the combustion face, and a piston thermal management composition coating disposed on the bottom face, the piston thermal management composition comprising increased thermal conductivity relative to the base material of the piston.

16. The apparatus of claim 15, wherein the piston thermal management composition comprises one of a nitride coating composition a titanium aluminum nitride composition, and an aluminum titanium nitride composition.

17. The apparatus of claim 16, wherein the piston thermal management composition comprises the nitride coating composition and the nitride coating composition is selected from the group consisting of an aluminum chromium nitride (Al-Cr-N) composition, an aluminum titanium nitride (Al-Ti-N) composition, a boron nitride (B-N) composition, a chromium nitride (Cr-N) composition, a molybdenum nitride (Mo-N) composition, a titanium aluminum nitride (Ti-Al-N) composition, and a titanium nitride (Ti-N) composition.

18. (canceled)

19. The apparatus of claim 16, wherein the piston thermal management composition comprises the titanium aluminum nitride composition and the titanium aluminum nitride composition is selected from the group consisting of Ti75Al25N, Ti66Al34N, Ti60Al40N, Ti55Al45N, and Ti50Al50N.

20. (canceled)

21. The apparatus of claim 16, wherein the piston thermal management composition comprises the aluminum titanium nitride composition and the aluminum titanium nitride composition is selected from the group consisting of Al55Ti45N, Al60Ti40N, and Al66Ti34N.

22. The apparatus of claim 15, wherein the piston thermal management composition comprises a diamond-like carbon (DLC) composition.

23. The apparatus of claim 22, wherein the DLC composition comprises a tetrahedral amorphous carbon (ta-C) composition.

24. The apparatus of claim 15, wherein the base material of the piston is comprises one of a steel composition and an aluminum composition.

25. (canceled)

26. The apparatus of claim 15, wherein the apparatuses is provided in a direct, in-cylinder injection hydrogen-combusting engine system.

27. The apparatus of claim 15, comprising a second piston thermal management composition coating disposed on the combustion face, the second piston thermal management composition comprising decreased thermal conductivity relative to the base material of the piston.

28. The apparatus of claim 27, wherein the second piston thermal management composition comprises a ceramic coating.

29. The apparatus of claim 28, wherein the ceramic coating is selected from the group consisting of alumina (Al2O3), hafnia (HfO₂), silica (SiO2), tantala (Ta₂O₅), titanium dioxide (TiO₂), yttria (Y₂O₃), yttria-stabilized zirconia (YSZ), and zirconia (ZrO₂).

30-54. (canceled)
